(19) United States
(12) Patent Application Publication
(10) Pub. No.: US 2009/0270193 A1
(43) Pub. Date: Oct. 29, 2009

(54) ANALYZING A MOTION OF A BOWLER

(75) Inventors: Neil B. Stremmel, Franklin, WI (US); Robert V. Roloff, Mukwanago, WI (US); Paul J. Ridenour, Waukesha, WI (US); James E. Jaryszak, Sturtevant, WI (US)

Correspondence Address: MICHAEL BEST & FRIEDRICH LLP, 100 E WISCONSIN AVENUE, Suite 3300, MILWAUKEE, WI, 53202, US

(73) Assignee: UNITED STATES BOWLING CONGRESS, Greendale, WI (US)

(21) Appl. No.: 12/108,964

(22) Filed: Apr. 24, 2008

(51) Int. Cl. A63D 5/04; G01L 5/00; G06F 19/00

(52) U.S. Cl. 473/55; 700/91; 73/865.4

(57) ABSTRACT

Systems and methods for analyzing a motion of a bowler. The system includes a plurality of cameras positioned around a capture volume. The capture volume includes a reference location. A plurality of markers is configured to be attached to the bowler and reflect light from the cameras. The cameras are configured to detect a first set of positions of the markers attached to the bowler. The markers are located within the capture volume. The cameras are also configured to transmit a first plurality of signals representative of the markers at the first set of positions. The cameras are configured to detect a second set of positions of the markers attached to the bowler. The markers are located within the capture volume. The cameras are also configured to transmit a second plurality of signals representative of the markers at the second set of positions. A computer system is configured to receive the first plurality of signals and the second plurality of signals related to the markers attached to the bowler, calculate a plurality of characteristics of the motion of the markers with respect to the reference location, and analyze the characteristics of the motion of the bowler to generate a quantitative description of the motion of the bowler. The quantitative description of the motion of the bowler is then correlated with a first result on a bowling lane.

### BACKGROUND

The present invention relates to analyzing the motion of a bowler using motion capture technology. More particularly, embodiments of the invention relate to quantitatively describing the motion of a bowler.

In the past, bowling coaches and instructors have filmed bowlers during a bowling motion. In some circumstances, the film of the bowler was reviewed by the player, coach, or both in an effort to help improve the bowler's bowling motion.

### SUMMARY

While capturing images on film (or even digital counterparts) can be used to help improve the motion of a bowler, such a technique is not always as useful as desired.

Motion capture analysis of a bowler provides a quantitative analysis of, for example, a bowler's stance, approach, and finish. The results provide a quantitative relationship between the bowler's technique and a result on a bowling lane. The motion of the bowler is quantified by tracking the motion of a plurality of markers attached to the bowler's body. A computer system then calculates characteristics such as positions, distances, angles, and velocities of the bowler's body during the motion.

In one embodiment, the invention provides a system for analyzing a motion of a bowler. The system includes a plurality of cameras positioned around a capture volume. The capture volume includes a reference location. A plurality of markers is configured to be attached to the bowler and reflect light from the cameras. The cameras are configured to detect a first set of positions of the markers attached to the bowler. The markers are located within the capture volume. The cameras are also configured to transmit a first plurality of signals representative of the markers at the first set of positions. The cameras are configured to detect a second set of positions of the markers attached to the bowler. The markers are located within the capture volume. The cameras are also configured to transmit a second plurality of signals representative of the markers at the second set of positions. A computer system is configured to receive the first plurality of signals and the second plurality of signals related to the markers attached to the bowler, calculate a plurality of characteristics of the motion of the markers with respect to the reference location, and analyze the characteristics of the motion of the bowler to generate a quantitative description of the motion of the bowler. The quantitative description of the motion of the bowler is then correlated with a first result on a bowling lane.

In another embodiment, the invention provides a method for analyzing a motion of a bowler that includes positioning a plurality of cameras around a capture volume which includes a reference location and attaching a plurality of markers to the bowler such that the plurality of markers define a shape of the bowler. The method also includes detecting, with the cameras, a first set of positions of the markers attached to the bowler, transmitting, from the cameras, a first plurality of signals representative of the markers at the first set of positions, detecting, with the cameras, a second set of positions of the markers attached to the bowler, and transmitting, from the cameras, a second plurality of signals representative of the markers at the second set of positions. Each marker is located within the capture volume. The method further includes receiving, at a computer system, the first plurality of signals and the second plurality of signals related to the markers attached to the bowler, calculating a plurality of characteristics of the motion of the markers with respect to the reference location, analyzing the characteristics of the motion of the bowler, generating a quantitative description of the motion of the bowler, and correlating the quantitative description of the motion of the bowler with a first result on a bowling lane.

In yet another embodiment, the invention provides a system for analyzing a motion of a bowler. The system includes a plurality of cameras positioned around a capture volume. The capture volume includes a reference location. The cameras are configured to detect a first position of the bowler located within the capture volume and transmit a first plurality of signals representative of the first position of the bowler. The cameras arc configured to detect a second position of the bowler located within the capture volume and transmit a second plurality of signals representative of the second position of the bowler. A computer system is configured to receive the first plurality of signals and the second plurality of signals representative of the first and second positions of the bowler, calculate a plurality of characteristics of the motion of the bowler with respect to the reference location, and analyze the characteristics of the motion of the bowler to generate a quantitative description of the motion of the bowler. T he quantitative description of the motion of the bowler is then correlated with a first result on a bowling lane.

Other aspects of the invention will become apparent by consideration of the detailed description and accompanying drawings.

### BRIEF DESCRIPTION OF THE DRAWINGS

FIG. 1 illustrates a motion capture system for analyzing a motion of a bowler.

FIG. 2 illustrates a capture volume of the motion capture system from FIG. 1.

FIG. 3 illustrates a front view and a back view of a plurality of markers attached to a bowler.

FIG. 4 illustrates a process for gathering motion capture data using the system of FIG. 1.

FIG. 5 illustrates a process for analyzing the motion capture data gathered from the process of FIG. 4.

FIG. 6 illustrates a bowler during step two of a five-step approach.

FIG. 7 illustrates a bowler during step three of a five-step approach.

FIG. 8 illustrates a bowler during step four of a five-step approach.

FIG. 9 illustrates a bowler during step five of a five-step approach.

FIG. 10 illustrates a position of a bowler's wrist during an arm swing.

FIG. 11 illustrates a position of a bowler's wrist at a low point of an arm swing.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

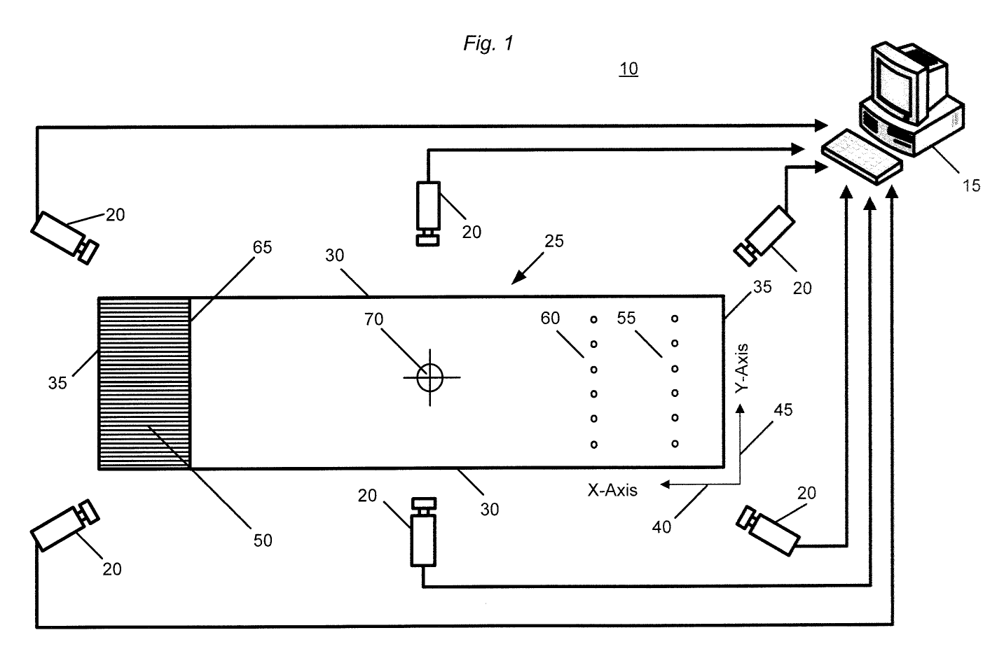

FIG. 1 illustrates a system 10 for analyzing a motion of a bowler. The system 10 includes a computer 15, a plurality of cameras or optical transducers 20, at least one optical marker (not shown), and an approach plane 25. The computer 15 includes, for example, a processing unit, a system memory, and a system bus. The system bus connects various computer components including the system memory to the processing unit. The system memory includes, in many instances, read only memory (ROM) and random access memory (RAM). The computer 15 also includes an input/output system that includes routines for transferring information between components within the computer 15. In other embodiments, the computer 15 can include additional, fewer, or different components. The computer 15 is also configured to receive a plurality of signals from the cameras 20.

Software included in the implementation of the system of FIG. 1 is stored in the ROM, RAM, or other memory of the computer 15. The software includes, for example, an operating system, one or more applications, program data, and other program modules. Additionally or alternatively, the computer 15 includes firmware applications and other processing instructions.

In some embodiments, the system 10 is implemented in a distributed computing environment where tasks are performed by remote processing devices that are linked through a communications network with program modules located in local and/or remote storage devices. The computer 15 can operate in a networked environment using connections to one or more remote computers. The network is, for example, a local area network (LAN) and/or a wide area network (WAN), including the Internet, a combination of the LAN and the WAN, or a different type of network.

The approach plane 25 includes two longitudinal boundaries 30 and two transverse boundaries 35. In the illustrated embodiment, the two longitudinal boundaries 30 and the two transverse boundaries 35 form a rectangularly shaped approach plane 25. The approach plane 25 is approximately 16 feet long (along an X-axis 40) and 5 feet wide (along a Y-axis 45). The 5 feet between the two longitudinal boundaries 30 is, in many instances, divided into a set of 39 boards. The boards are used by a bowler to align the bowling motion or a part of the bowling motion in the approach plane 25. In other embodiments, the approach plane 25 can be different shapes and sizes.

The approach plane 25 extends, in many instances, into a bowling lane 50. For example, a bowler's approach begins at a first set of approach dots 55 or a second set of approach dots 60 and extends past a foul line 65. To include the entire motion of the bowler in a capture volume (described below), the approach plane 25 extends approximately two feet into the bowling lane 50. By extending the approach plane 25 into the bowling lane 50, the motion of the bowler (including an extended arm motion) is entirely contained within the capture volume.

The approach plane 25 also includes a primary reference point or origin 70. The origin 70 is approximately half-way between the two transverse boundaries 35 and half-way between the two longitudinal boundaries 30 of the approach plane 25 (at approximately the 20^{th} board). The origin 70 is used as a reference point for calculating data measurements and, in many instances, defines the center of the approach plane 25.

The cameras 20 are, for example, digital cameras that emit light and detect reflected light from the markers. The cameras 20 include a sensor such as a CMOS sensor or a CCD sensor. Each camera 20 is positioned at a respective capture point around the approach plane 25 and transmits a signal either through wires or wirelessly to the computer 15 indicating the position of the bowler. The signals are transmitted at a predefined frame rate for the cameras 20. The markers are attached to a bowler such that the bowler is able to execute an entire bowling motion with minimal obstruction. The markers and their placement on a bowler are described below. The number of cameras 20 required for the system 10 depends, in part, on the number of markers used. Each of the markers should be visible through a complete motion of the bowler. Therefore, the greater the number of markers used or the larger a distance traveled during a motion is, the greater the number of cameras 20 required. In the illustrated embodiment, the system 10 uses six cameras 20. One camera 20 is placed near each of the corners of the approach plane 25 and an additional camera 20 is positioned at approximately a midpoint of each of the two longitudinal boundaries 30. The cameras 20 establish and define the capture volume which includes the length and the width of the approach plane 25. The capture volume extends, for example, seven feet above the approach plane 25. The height of the capture volume is modified by adjusting the height of each of the cameras 20. In other embodiments of the invention, other motion detection systems can be used. For example, a marker-less motion detection system can be used in place of the optical system described above.

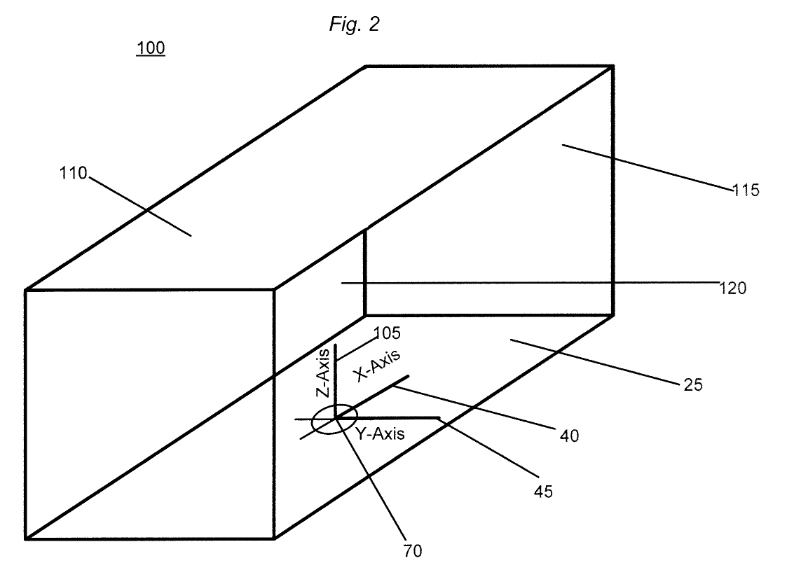

The capture volume 100 of the system 10 is illustrated in FIG. 2. The capture volume 100 is a space defined by the placement and height of the cameras 20. The shape and size of the capture volume 100 also depends on the number of the cameras 20 used in the system 10. The origin 70 is illustrated as being in a bottom plane (the approach plane 25) of the capture volume 100. The origin 70 is defined by the intersection of the X-axis 40, the Y-axis 45, and a Z-axis 105. The X-axis 40, the Y-axis 45, and a Z-axis 105 provide references from which position, distance, angle, and velocity measurements related to the motion of the bowler are calculated. Additionally, the X-axis 40 and the Y-axis 45 form an XY-plane 110; the Y-axis 45 and the Z-axis 105 form a YZ-plane 115; and the X-axis 40 and the Z-axis 105 form an XZ-plane 120. The XY-plane, the YZ-plane, and the XZ-plane can be positioned at any point along the Z-axis, the X-axis, and the Y-axis, respectively.

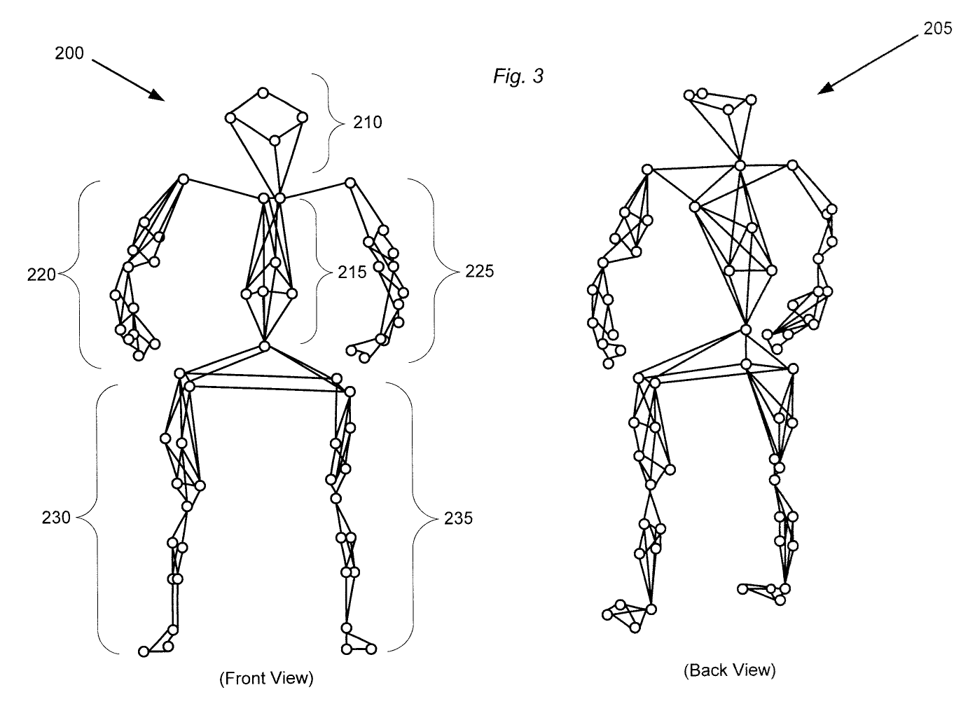

FIG. 3 illustrates a wire-frame construction of the bowler from a front side 200 and a back side 205, according to an embodiment of the invention. Other wire-frame constructions are possible in other embodiments. The illustrated embodiment should in no way limit the possible wire-frame constructions to the illustrated number of markers or the illustrated linkages. In FIG. 3 the bowler is standing at the origin 70. A total of 66 markers are attached to the bowler. The markers define a shape of the bowler. For example, markers are placed on a head 210, a torso 215, a right arm 220, a left arm 225, a right leg 230, and a left leg 235 of the bowler. The markers placed on the torso 215 of the bowler include markers placed at a lower back area, a middle back area, an upper back area, a right shoulder, a left shoulder, and a chest of the bowler. The markers placed on the right arm 220 include markers placed at a right upper arm, a right elbow, a right forearm, a right wrist, and a right hand. The markers placed on the left arm 225 include markers placed at a left upper arm, a left elbow, a left forearm, a left wrist, and a left hand. The markers placed at the right leg 230 include markers at a right hip, a right thigh, a right knee, a right shin, a right ankle, and a right foot. The markers placed at the left leg 235 include markers at a left hip, a left thigh, a left knee, a left shin, a left ankle, and a left foot. The markers that are located at, for example, the right arm 220, the left arm 225, the right leg 230, and the left leg 235 are attached to plates (not shown) that each include four sensors. The plates are attached to the bowler by, for example, a Velcro strap. Markers placed at joints or other locations in which plates cannot be used are adhesively attached to the bowler using, for example, an adhesive tape, an adhesive gel, or the like. In other embodiments, additional markers are placed at other locations on the bowler.

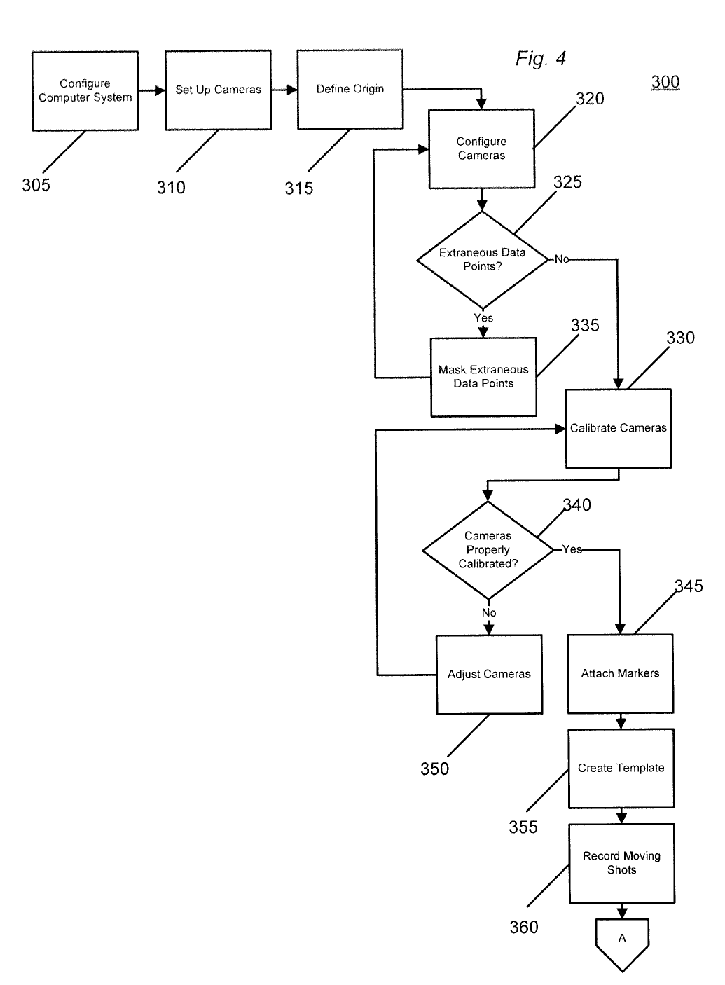

FIG. 4 illustrates a process 300 for collecting data related to the motion of the bowler. The process 300 begins with configuring the computer 15 (step 305). Configuring the computer 15 includes, among other things, installing motion capture software and data analysis software applications, defining a set of variables corresponding to critical areas of a bowler, and configuring the analysis software to generate quantitative descriptions of the bowling motion. After the computer is configured (step 305), the cameras 20 are set up (step 310). Each camera 20 includes, for example, a tripod and a swivel for adjusting the height and direction of the camera 20. The cameras 20 are positioned as described above with respect to FIG. 1. After step 310, the origin 70 is defined as a reference point in the approach plane 25. In many instances, the origin 70 is located at approximately the center of the approach plane 25. To define the origin 70, a reference object with a plurality of markers is positioned in the approach plane 25. To accurately define the origin 70, each of the markers of the reference object should be visible to each of the cameras 20. If a camera 20 is unable to detect one or more of the markers on the reference object, the cameras 20 are adjusted until each marker is detectable by each camera 20. 100311 After step 315, the cameras 20 are configured (step 320). Configuring the cameras 20 includes determining whether any extraneous data points are present in the capture volume 100 (step 325). For example, an ideal surface for using motion capture technology is a carpeted surface or another similarly unreflective surface. On a surface such as a bowling lane, which is coated with wax and is highly reflective, there is a relatively high potential for extraneous light reflections to be detected by one or more of the cameras 20. When configuring the cameras 20, if no extraneous data points are present in the capture volume 100, the process 300 proceeds to step 330. However, if extraneous data points are present, they must be “masked” to prevent them from obscuring the data gathered from the motion of the bowler (step 335). After each marker is detectable by each camera and there are no extraneous data points, a first static image of the capture volume 100 is captured.

Following the configuration of the cameras 20, the cameras 20 are calibrated (step 330). Calibrating the cameras 20 involves sweeping a reference wand of a known length through the capture volume 100. The wand calibration ensures that a direct measurement of an object of a known size has been made by all cameras 20 throughout the capture volume 100. The reference wand includes, for example, four markers. Each camera 20 also includes a known lens focal length. After the sweep is complete, a data analysis application is executed based on data from the camera calibration. If the cameras are properly calibrated (step 340), the wand length and the camera lens focal length are approximately equal to the known values. The process 300 then proceeds to step 345. If an error has occurred or the wand length and camera lens focal length are not substantially similar to the known values, the cameras 20 are adjusted (step 350) and recalibrated (step 330).

After the cameras 20 are calibrated, the markers are attached to the bowler as described above with respect to FIG. 3 (step 345). Each marker is identified with a unique name. For example, each marker is identified by its location on the bowler. In many instances, identifying each marker is only required once for a respective set of markers. After each marker has been identified, each marker is connected to at least one other marker using a respective linkage. An instructor then enters a height and a weight of the bowler. A second static image, with the bowler standing still, and motion capture images, with the bowler executing an entire bowling motion, are taken. After the bowler has executed a full range of motion and the captured data has been “cleaned-up” (described below) a bowler template is created (step 355). The template defines maximum and minimum distances that can exist between markers of relatively fixed positions. The range provided by the minimum and maximum distance values enables the computer 15 to track each marker and maintain each linkage so long as the minimum and maximum distance values are not exceeded.

The bowler template is specific to the bowler for which the template was created. However, a sufficient set of bowler templates can reduce or eliminate a need to create a template for each bowler that uses the system 10. For example, a sufficient set of bowler templates includes templates for a variety of heights and weights such that there is at least one template stored in the computer 15 that corresponds to the placement of the markers on each bowler that uses the system 10. A sufficient set of bowler templates reduces the time required to set up and calibrate the system 10.

After the template has been created, the bowler executes a set of, for example, ten bowling motions (step 360). Depending on the correlation between the template and the markers placed on the bowler, the system is not, in some instances, able to accurately follow each of the markers and correctly apply each of the linkages. The instructor is then required to correct or “clean-up” the data. If an error occurs, the instructor is required to re-identify a marker or re-link two markers. When a full set of data has been collected and cleaned, the data is analyzed and a quantitative analysis of the bowler's motion is generated as described below.

The quantitative analysis of the bowler's motion is presented to the bowler in a variety of ways. For example, an instructor can provide feedback to a bowler for each of the executed bowling motions. The instructor uses a set of raw data (un-cleaned) as well as a wire-frame video of the movement of each marker to provide a preliminary quantitative analysis for each motion. Additionally or alternatively, by observing the wire-frame video of the motion of the bowler and the quantitative relationships between the critical parts of the bowling motion only after the execution of all the bowling motions, the instructor provides the bowler with a comprehensive quantitative analysis of the bowling motion. In other embodiments of the invention, a bowler using the system 10 receives the quantitative analysis of their bowling motion without the assistance of an instructor. For example, the data analysis application is configured such that the quantitative results are automatically generated and the system 10 provides a quantitative, written, and/or audible description of the bowler's motion. The quantitative description is then compared with an associated result of the bowling motion on the bowling lane 50 (e.g., a number of bowling pins knocked down, the position of the bowling pins knocked down, etc.).

As an illustrative example, a timing of the bowler's motion or a “stroker timing” is an important component to a successful bowling motion. The bowling motion can be divided into three primary parts, a stance, an approach, and a finish. The stance and the finish are static beginning and ending positions, respectively, which frame the approach. A common approach technique is the four-step approach. The overall timing of the bowling motion is heavily dependent on proper timing of each of the steps of the four-step approach. In an ideal four-step approach (using classical timing), the bowling ball is away from and forward of the bowler's body during the first step. During the second step, the bowling ball is in line with the bowler's non-ball side leg. During the third step, the bowling ball is at the top of the backswing. During the fourth step, the bowling ball is in line with the non-ball side ankle. Using the system 10, the position of the wrist (right or left depending on which hand the bowler uses to hold the bowling ball) with respect to the knee position during the second step, the position and height of the bowling ball swing during the third step, and a distance between the ball-side wrist and non-ball-side ankle during the fourth step are described quantitatively.

In another illustrative embodiment, the system 10 quantifies the bowler's knee bend at the foul line 65 by measuring an angle between the right or left hip and the right or left shin (depending on which leg is the non-ball side leg). The quantitative analysis of the bowler's knee bend demonstrates the amount of leverage the bowler is supplying to the shot at the foul line and if the knee is continuing forward due to momentum. A bowler with a low knee bend angle stands more upright at the foul line 65, drops the ball at release, and loses the momentum the backswing imparted to the bowling ball. A large knee bend, on the other hand, promotes balance at the foul line 65. However, a bowler can have too much knee bend. Too much knee bend reduces the momentum of the ball in the direction of the pins and increases the momentum of the ball in the direction of the floor.

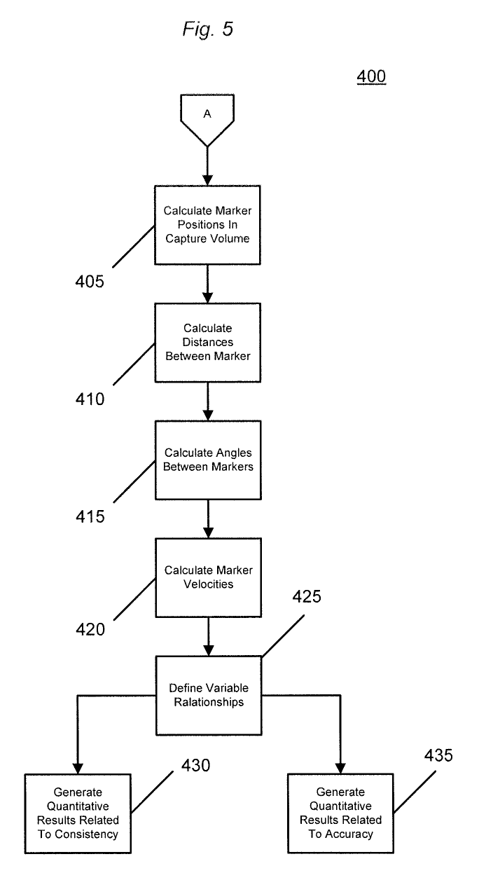

FIG. 5 illustrates a process 400 for quantitatively analyzing the motion of the bowler. After the data related to the motion of the bowler has been gathered as described above with respect to FIG. 4, the computer 15 calculates positions for each of the markers within the capture volume 100 (step 405). Each measured position is with respect to the origin and is represented by an X-coordinate, a Y-coordinate, and a Z-coordinate. The position of each marker is calculated at a predefined time interval (for each frame captured by the cameras 20). For example, if the cameras 20 are operating at 200 frames per second, 200 positions (X, Y, and Z coordinates) for each marker are calculated every second. After the position of each marker has been calculated, distances between the markers are calculated (step 410). Depending on the goal for analyzing the motion of the bowler (i.e., a specific aspect of the motion that the bowler is trying to improve), different distances are calculated. For example, with respect to the example described above related to the timing of a four-step approach the height of the ball during the backswing of the second step and the distances between the ball-side wrist and the non-ball-side ankle during the fourth-step are important to the result on the bowling lane 50.

After each of the distances has been calculated, angles between markers are calculated (step 415). For example, angles formed by the markers on the thigh, the knee, and the shin, of the left leg and the right leg are calculated to determine knee bend. Similarly, the angle formed by the markers at the upper arm, the elbow, and the forearm of the right arm and the left arm are calculated to determine arm bend. Additionally, angles between the markers that define the hips and shoulders, among others, are calculated to provide a quantitative description of a posture and a balance of the bowler. Other angles that are calculated during analysis include an angle between the shin, the ankle, and the foot of the right and left legs, as well as a neck angle and a spine angle.

Following step 415, a plurality of marker velocities are calculated (step 420). For example, the velocity of the wrists, the elbows, the feet, the hips, and the shoulders with respect to at least one of the XY-plane 110, the YZ-plane 115, and the XZ-plane 120 are calculated. Additionally, angular velocities of, for example, an arm swing are calculated with respect to at least one of the XY-plane 110, the YZ-plane 115, or the XZ-plane 120.

After each of the positions, distances, angles, and velocities have been calculated, relationships are defined by the instructor to describe the motion of the bowler (step 425). For example, the instructor defines relationships between positions, distances, and angles during the stance to quantitatively describe the bowler's posture, balance, and alignment. Additionally, as a consequence of each bowler having a unique bowling motion, the quantitative analysis of a bowling motion compared to an “ideal” bowling motion does not, in some instances, provide constructive information. Therefore, the quantitative description of the motion of the bowler is analyzed in at least two ways: consistency and accuracy.

Step 430 illustrates the analysis of the quantitative description with respect to consistency (step 430). For example, a standard deviation between the ten executed bowling motions is calculated. Therefore, the quantitative analysis of the consistency of the bowler's motion is combined with the result of the bowling motion on the lane 50 to describe the differences between the motion of the bowler when the bowler rolled a strike and when the bowler rolled a gutter ball. For example, a deviation of the bowler's motion from one bowling motion to the next is calculated for a plurality of positions, distances, angles, and velocities of the markers. A comparison is then made between the bowling motions that were the most successful and those that were not as successful. The bowler can use the comparison to correct for the deviations in the bowling motions and improve the consistency of the results of his or her bowling motion on the lane 50.

Step 435 illustrates the analysis of the quantitative description of the motion of the bowler with respect to accuracy (step 435). The accuracy of the motion of the bowler is described with respect to relationships between positions, distances, angles, and velocities of the “ideal” bowling motion. A bowler provides a maximum amount of energy in the direction of the bowling pins and has the bowling ball travel along a desired path when specific markers are in line with the XY-plane 110, the YZ-plane 115, or the XZ-plane 120. For example, the ball-side wrist and the non-ball side knee, in many instances, are in line (parallel) with the XZ-plane 110 at the finish. If the quantitative description of the bowler's motion indicates that the ball-side wrist and the non-ball side knee are not in line with the XZ-plane 120, then the instructor can show the bowler a deviation from the XZ-plane 120 both visually and quantitatively.

Additionally or alternatively to the process 400, the relationships defined by the instructor are defined before data is gathered or calculations of positions, distances, angles, and velocities are performed. Then, after the data has been gathered, the analysis software application outputs the quantitative description of the relationships between the positions, distances, angles, and velocities during the stance, the approach, and the finish. The instructor is then able to, if needed, define additional relationships between the positions, distances, angles, and velocities to more accurately describe the motion of the bowler.

The quantitative analysis of the bowling motion also allows for different levels of instruction for the bowler. Bowling instruction is divided, in many instances, into two primary categories, hard skill instruction and soft skill instruction. If the instructor gives the bowler soft skill instruction, the instructor reviews the visual and quantitative results of the bowling motion analysis, determines what the bowler is doing incorrectly, and instructs the bowler about how to correct the errors in their motion (e.g. the bowler's timing is off, the bowler's knees do not have enough bend, etc.). Hard skill instruction, in contrast, is a technical description of what the bowler is doing incorrectly. For example, the instructor tells the bowler that their ball-side wrist is lagging the non-ball side ankle by 0.2 seconds during step two of the approach.

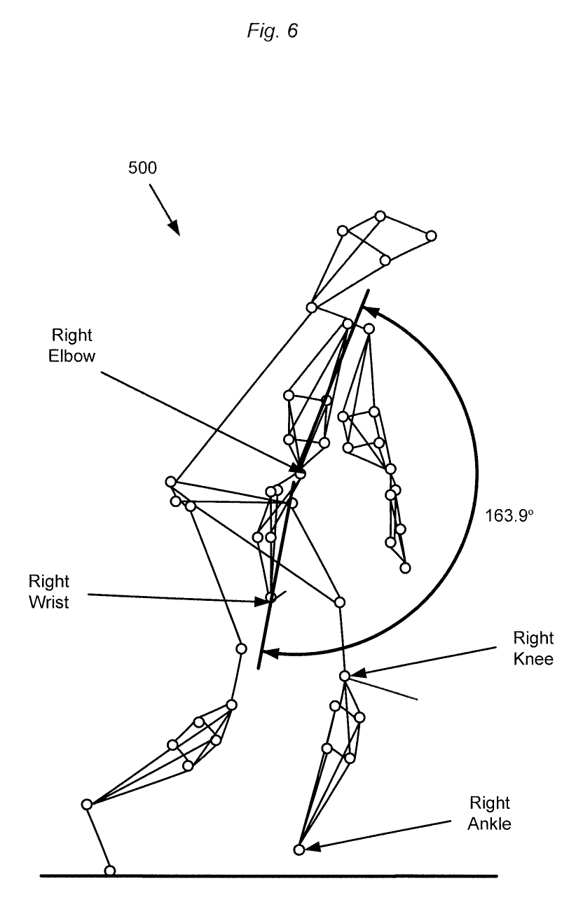

FIGS. 6-10 illustrate a motion of the bowler 500 and an associated quantitative analysis (hard skill instruction). The four-step approach described above is described with respect to classical timing. The analysis associated with FIGS. 6-10 is related to the accuracy of the bowler 500's motion in relation to proper execution of classical timing and power timing during a five-step approach. Power timing is, in many instances, the timing used by professional bowlers. The analysis set forth below is described with respect to quantitative differences between classical timing and power timing during the motion of the bowler 500.

As described above, the motion of the bowler 500 includes three primary stages, the stance, the approach, and the finish. The bowler 500 is, in many instances, positioned at one of the first or second sets of approach dots 55 or 60 during the stance. A bowling ball is supported in the bowler 500's right or left hand. One of the more important aspects of the stance is stability and is quantitatively described with respect to angles between markers, distances between markers, and relative positions of, for example, the toes, the wrists, the elbows, and the head. The angles calculated between the markers include, among others, angles between the shins and the thighs and angles of the hips, spine, shoulders, and wrists with respect to the XY-plane 110, YZ-plane 115, and the XZ-plane 120. Each of these values, among others, is calculated by the system 10 and is calculated throughout the motion of the bowler 500. The system 10 analyzes the calculated values and assists the bowler 500 in determining which values need correction. Examples of analysis associated with some of these values are described below.

The five-step approach begins with a speed step (first step). The first step is taken with the non-ball side foot and starts the bowler 500's momentum moving forward. Steps 2-5 of the five-step approach are similar to steps 1-4 of the four-step approach. Differences between steps 2-5 of the five-step approach and steps 1-4 of the four-step approach (described above) appear, for example, when a bowler 500 executes a bowling motion using power timing as opposed to classical timing. The second step of the five-step approach is a critical step for power timing. FIG. 6 illustrates the bowler 500 during the second step of the five-step approach. The bowler 500's right ankle is perpendicular to the ground, and the bowler 500's right foot is flat on the ground. At this stage using classical timing, a bowler's wrist is parallel to the ground and the bowler 500's right elbow angle is approximately 90°. However, FIG. 6 illustrates the bowler 500's right elbow angle is at an angle of 163.92° and is already past being perpendicular to the ground. Therefore, the bowler 500 is exhibiting signs of power timing during step two of the approach.

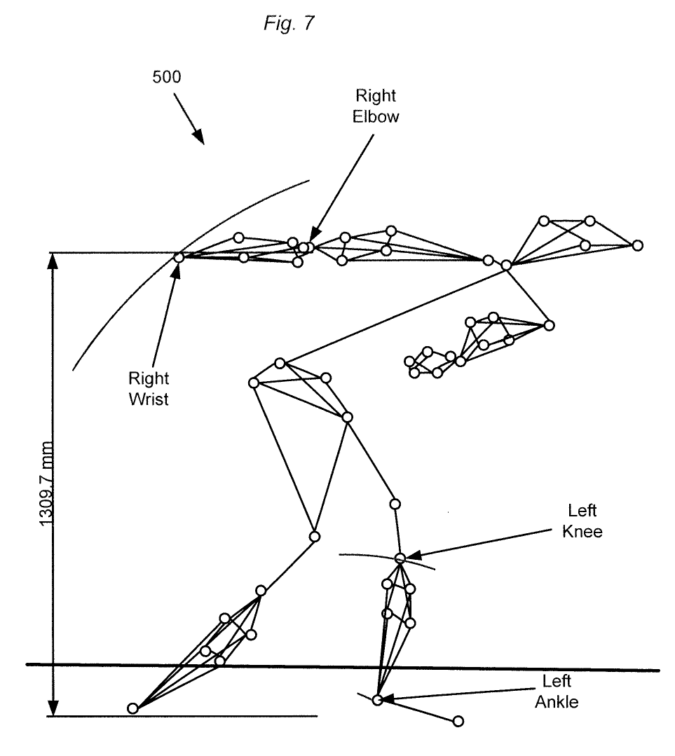

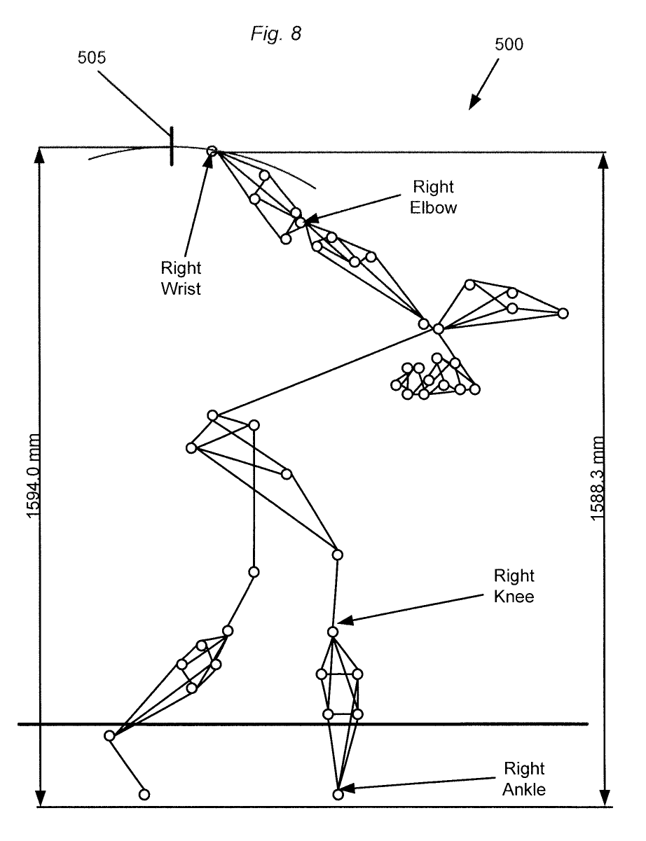

FIG. 7 illustrates the bowler 500 during the third step of the five-step approach. When using classical timing, the bowler 500 is initiating a backswing and the bowler 500's wrist and elbow are perpendicular to the floor. However, in FIG. 7, the bowler's right wrist and elbow are parallel to the ground and the ball has reached a height of 1309.7 mm. FIG. 8 illustrates the bowler 500 during the fourth step of the five-step approach. When using classical timing, the bowler 500's right arm is at a top of the backswing 505 and the bowling ball is at an apex. As FIG. 8 illustrates, the bowler 500's right wrist is slightly past the top of the backswing 505. The apex of the bowler 500's right wrist during the backswing in FIG. 8 is 1594.0 mm above the ground. However, the bowler 500's right wrist is past the apex and is 1588.3 mm above the ground during the fourth step of the approach. Therefore, while the bowler 500 continues to exhibit signs of power timing, the bowler 500's approach is closer to classical timing than it was during steps 1-3 of the five-step approach. If the motion of the bowler 500 or the result of the motion of the bowler 500 (e.g., the number of bowling pins knocked down) benefits more from a power timing approach than a classical timing approach or the bowler 500 wants to use the power timing approach, the bowler 500 is instructed that their backswing must be faster from step three to step four of the five-step approach.

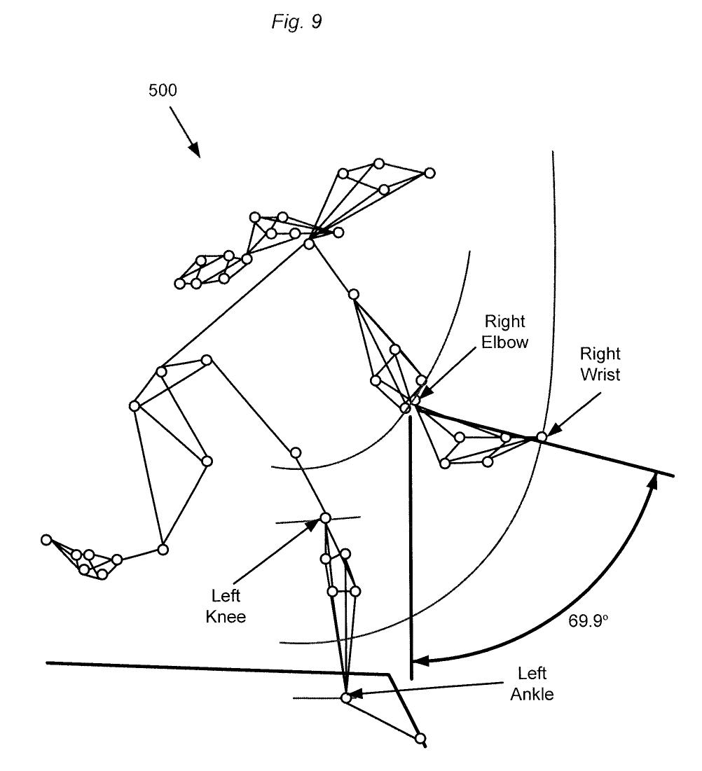

FIG. 9 illustrates step five of a five-step approach. In particular, FIG. 9 illustrates the end of the fifth step of the approach. The end of the approach is determined by the point at which the bowler 500's left ankle stops. FIG. 9 illustrates the bowler 500's left ankle stopping as the bowler 500 pulls up their right foot. The bowler 500's left knee continues forward. In classical timing, the bowler 500's right elbow and right wrist are perpendicular to the ground. however, as shown in FIG. 9, the right wrist and right elbow are not perpendicular to the ground. Instead, the right wrist and the right elbow form an angle of 69.9° with respect to a line perpendicular to the ground. The bowler 500 is now in tweener timing, approximately half-way between classical timing and power timing. If the bowler 500 is to transition to power timing the bowler 500 must increase the speed of their arm swing from steps two to three and three to four. Alternatively, if the bowler 500 is to transition to classical timing, the bowler 500 must slow down their arm swing from step two to step three and step three to step four.

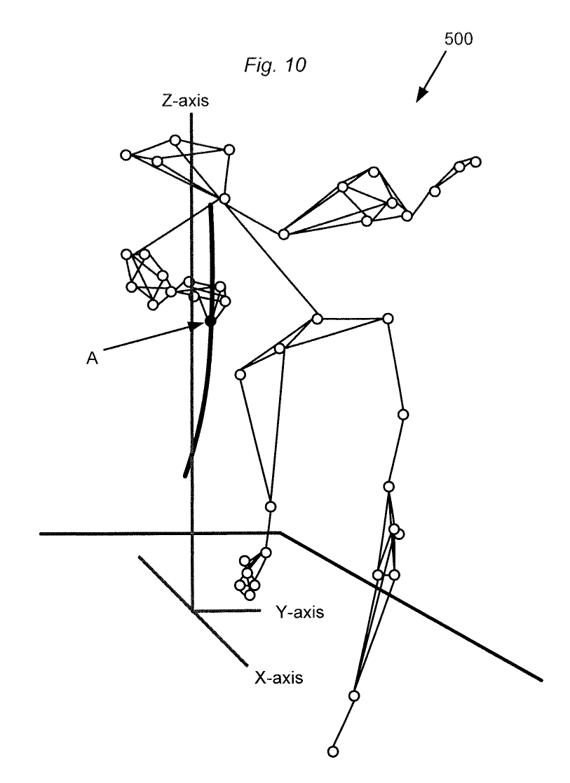

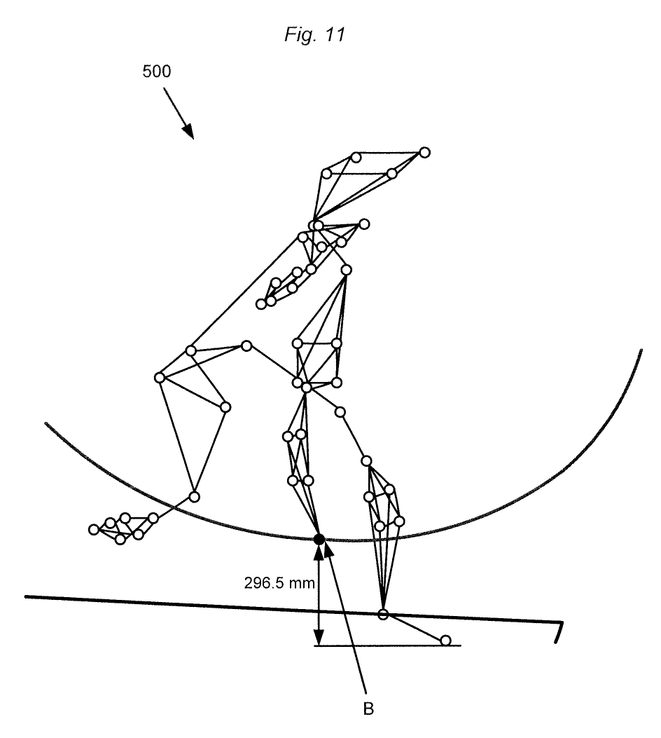

FIGS. 10 and 11 illustrate the motion and position of the bowler's right wrist during the arm swing. Ideally, the bowler 500's arm swing is parallel to (planar with) the XZ-plane. However, the bowler 500's arm swing is not consistently parallel to the XZ-plane. Possible causes for the bowler 500's arm swing being off plane include the bowler rotating the bowling ball too early and having a high axis of rotation. For example, the bowler 500's initial wrist position (point A) is at 120.5 mm along the Y-axis. The bowler 500's wrist speed and wrist acceleration are 3.38 m/s and 19.78 m/s², respectively. The bowler 500's wrist then drifts to a position of −46.5 mm (point B in FIG. 11) along the Y-axis at the bottom of the arm swing. At the bottom of the arm swing (flat spot of the arm swing) the bowler 500's wrist speed is (ideally) at a maximum. In FIG. 11, the flat spot occurs when the bowler 500's wrist is 296.5 mm above the ground. However, due to the bowler 500's armswing being off plane with the XZ-plane, the bowler 500 is not maximizing the speed of their wrist in the direction of the XZ-plane. At point B, the bowler 500's wrist speed is 8.67 m/s with respect to the XZ-plane. Additionally, the bowler 500's knee bend (angle between ankle, knee, and thigh) is also calculated to be 36.6 degrees when the bowler 500's wrist is at point B. As described above, the bowler 500's knee bend is related to the amount of momentum that the bowler 500 is able to impart to the bowling ball in the direction of the XZ-plane (in the direction of the bowling pins). A slightly larger knee bend can improve the transfer of momentum through the backswing and improve the bowler's balance during the approach.

Thus, the invention provides, among other things, a system and method for quantitatively analyzing a motion of a bowler. The system includes, among other things, a plurality of cameras, a plurality of markers, and a computer system configured to receive a plurality of signals from the cameras, calculate a plurality of characteristics of the motion of the bowler, and generate a quantitative description of the motion of the bowler. Various features and advantages of the invention are set forth in the following claims.

What is claimed is:

1. A system for analyzing a motion of a bowler, the system comprising:
a plurality of cameras positioned around a capture volume, the capture volume including a reference location;
a plurality of markers configured to be attached to the bowler, wherein the plurality of markers define a shape of the bowler;
the cameras configured to detect a first set of positions of the markers attached to the bowler, the markers located within the capture volume, the cameras further configured to transmit a first plurality of signals representative of the markers at the first set of positions;
the cameras configured to detect a second set of positions of the markers attached to the bowler, the markers located within the capture volume, the cameras further configured to transmit a second plurality of signals representative of the markers at the second set of positions; and
a computer system configured to receive the first plurality of signals and the second plurality of signals related to the markers attached to the bowler, calculate a plurality of characteristics of the motion of the markers with respect to the reference location, and analyze the characteristics of the motion of the bowler to generate a quantitative description of the motion of the bowler;
wherein the quantitative description of the motion of the bowler is correlated with a first result on a bowling lane.

2. The system of claim 1, wherein the capture volume includes an approach plane.

3. The system of claim 2, wherein the approach plane extends a first distance into the bowling lane.

4. The system of claim 1, wherein the plurality of characteristics of the motion of the markers includes a set of calculated positions and a set of calculated distances.

5. The system of claim 1, wherein the plurality of characteristics of the motion of the markers includes a set of calculated velocities of the markers.

6. The system of claim 1, wherein the motion of the bowler includes a stance, an approach, and a finish of the bowler.

7. The system of claim 1, wherein the quantitative description of the motion of the bowler is analyzed with respect to consistency and accuracy.

8. A method for analyzing a motion of a bowler, the method comprising:
positioning a plurality of cameras around a capture volume, the capture volume including a reference location;
attaching a plurality of markers to the bowler, wherein the plurality of markers define a shape of the bowler;
detecting, with the cameras, a first set of positions of the markers attached to the bowler, the markers being located within the capture volume;
transmitting, from the cameras, a first plurality of signals representative of the markers at the first set of positions;
detecting, with the cameras, a second set of positions of the markers attached to the bowler, the markers being located within the capture volume;
transmitting, from the cameras, a second plurality of signals representative of the markers at the second set of positions; and
receiving, at a computer system, the first plurality of signals and the second plurality of signals related to the markers attached to the bowler;
calculating a plurality of characteristics of the motion of the markers with respect to the reference location;
analyzing the characteristics of the motion of the markers;
generating a quantitative description of the motion of the bowler; and
correlating the quantitative description of the motion of the bowler with a first result on a bowling lane.

9. The method of claim 8, wherein calculating a plurality of characteristics of the motion of the markers with respect to the reference location includes calculating a set of positions and a set of distances.

10. The method of claim 8, wherein calculating a plurality of characteristics of the motion of the markers with respect to the reference location includes calculating a set of velocities of the markers.

11. The method of claim 8, further comprising analyzing the quantitative description of the motion of the bowler with respect to consistency and accuracy.

12. The method of claim 8, further comprising defining an approach plane within the capture volume, wherein the approach plane extends a first distance into the bowling lane.

13. The method of claim 8, further comprising attaching a plurality of markers to the bowler, wherein the plurality of markers define a shape of the bowler.

14. The method of claim 8, wherein generating a quantitative description of the motion of the bowler includes generating a quantitative description of a stance, an approach, and a finish of the bowler.

15. A system for analyzing a motion of a bowler, the system comprising:
a plurality of cameras positioned around a capture volume, the capture volume including a reference location;
the cameras configured to detect a first position of the bowler located within the capture volume, the cameras further configured to transmit a first plurality of signals representative of the position of the bowler;
the cameras configured to detect a second position of the bowler located within the capture volume, the cameras further configured to transmit a second plurality of signals representative of the second position of the bowler; and
a computer system configured to receive the first plurality of signals and the second plurality of signals representative of the first and second positions of the bowler, calculate a plurality of characteristics of the motion of the bowler with respect to the reference location, and analyze the characteristics of the motion of the bowler to generate a quantitative description of the motion of the bowler;
wherein the quantitative description of the motion of the bowler is correlated with a first result on a bowling lane.

16. The system of claim 15, wherein the capture volume includes an approach plane.

17. The system of claim 15, wherein the plurality of characteristics of the motion of the bowler includes a set of calculated positions and a set of calculated distances.

18. The system of claim 15, wherein the plurality of characteristics of the motion of the bowler includes a set of calculated velocities.

19. The system of claim 15, wherein the motion of the bowler includes a stance, an approach, and a finish.

20. The system of claim 15, wherein the quantitative description of the motion of the bowler is analyzed with respect to consistency and accuracy.
